(19) United States
(12) Patent Application Publication
(10) Pub. No.: US 2012/0191511 A1
(43) Pub. Date: Jul. 26, 2012

(54) VEHICLE RENTAL MANAGEMENT SYSTEM AND METHOD

(75) Inventor: JIAN-HUI LI, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/329,339

(22) Filed: Dec. 19, 2011

(30) Foreign Application Priority Data
Jan. 24, 2011 (CN) 201110025749.8

(51) Int. Cl. G06Q 20/32; G06Q 40/02; G07B 15/00; G08B 29/00

(52) U.S. Cl. 705/13; 340/5.61; 705/40

(57) ABSTRACT

A system and method for vehicle rental management generates and displays a park identification (ID) number configurable to change periodically. The method further receives a first message containing a vehicle ID number of a vehicle from a mobile phone, sends a unlock code for unlocking the vehicle to the mobile phone. The method receives a second message containing the vehicle ID number and a park ID number from the mobile phone, and sends a lock signal to the second communication module to lock the vehicle. The method receives a feedback signal for confirming that the vehicle is locked, and times between the send the unlock code step and the receive the feedback signal step.

### BACKGROUND

1. Technical Field

The disclosure generally relates to vehicle rental management systems and methods, and particularly to a vehicle rental management system and method based on wireless communications.

2. Description of the Related Art

Urbanization of cities have caused greater traffic jams and environmental pollution. Now many governments are advocating environmentally friendly activities, such as renting bicycles, or electric vehicles, for example. These rental vehicles can be difficult to manage, and can easily be lost or stolen.

Therefore, there is room for improvement within the art.

### BRIEF DESCRIPTION OF THE DRAWINGS

Many aspects of an exemplary vehicle rental management system and method can be better understood with reference to the following drawings. The components in the drawings are not necessarily drawn to scale, the emphasis instead being placed upon clearly illustrating the principles of the exemplary vehicle rental management system and method. Moreover, in the drawings, like reference numerals designate corresponding parts throughout the several views. Wherever possible, the same reference numbers are used throughout the drawings to refer to the same or like elements of an embodiment.

FIG. 1 is a block diagram of a vehicle rental management system in communication with a mobile phone, according to an exemplary embodiment.

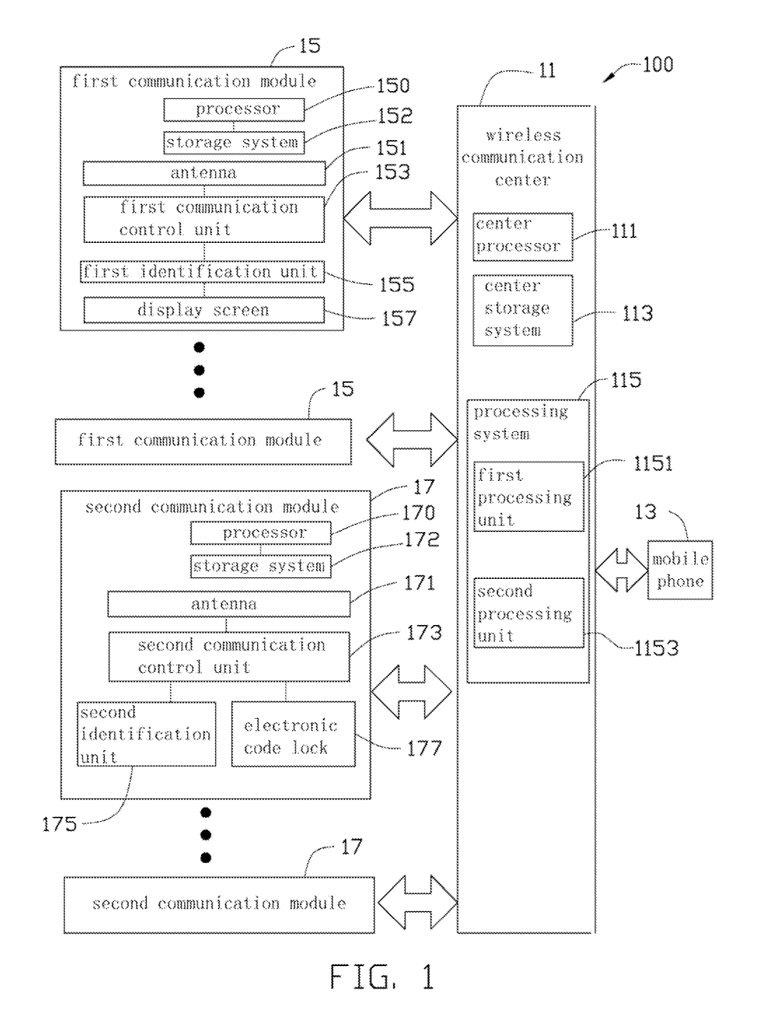

FIG. 2 is a flowchart of one embodiment of a method for vehicle rental management.

### DETAILED DESCRIPTION

The drawing is a block diagram of a vehicle rental management system 100 in communication with a mobile phone 13, according to an exemplary embodiment. The vehicle rental management system 100 includes a wireless communication center 11, a plurality of first communication modules 15, and a plurality of second communication modules 17. The plurality of first communication modules 15 and the plurality of second communication modules 17 communicate with the wireless communication center 11 via a wireless network (not shown). A user can communicate with the wireless communication center 11 via a mobile phone 13.

The wireless communication center 11 includes a center processor 111, a center storage system 113, and a processing system 115. In one embodiment, the processing system 115 includes a first processing unit 1151 and a second processing unit 1153. The units 1151 and 1153 may include one or more computerized instructions in the form of one or more programs that are stored in the center storage system 113, and executed by the center processor 111 to perform operations of the wireless communication center 11. In general, the word “unit”, as used herein and hereafter, refers to logic embodied in hardware or firmware, or to a collection of software instructions, written in a programming language, such as, Java, C, or Assembly. One or more software instructions in the units may be embedded in firmware, such as in an EPROM. The units described herein and hereafter may be implemented as either software and/or hardware modules and may be stored in any type of computer-readable medium or other storage device.

The plurality of first communication modules 15 can be located in a plurality of common areas, such as vehicle parking lots (not shown) of a city. The vehicle parking lots are located in different places, and each first communication module 15 can be located in one vehicle parking lot. The first communication module 15 includes a processor 150, a storage system 152, an antenna 151, a first communication control unit 153, a first identification unit 155, and a display screen 157. The units 153 and 155 may include one or more computerized instructions in the form of one or more programs that are stored in the storage system 152 of the first communication module 15, executed by the processor 150 to perform operations of the first communication module 15. The first communication control unit 153 communicates with the wireless communication center 11 via the antenna 151. The identification unit 155 generates an ID number of the plurality of common areas (“park ID number”), under the control of the first communication control unit 153 and the display screen 157 displays the park ID number.

The plurality of second communication modules 17 can be positioned on/in a plurality of vehicles (not shown) in the city, such as bicycles, cars, motor bikes, for example. The vehicles, in one example, can be parked in the plurality of vehicle parking lots. Each second communication module 17 can be positioned on/in one vehicle. The second communication module 17 includes a processor 170, a storage system 172, an antenna 171, a second communication control unit 173, a second identification unit 175, and an electronic code lock 177. The units 173 and 175 may include one or more computerized instructions in the form of one or more programs that are stored in the storage system 172 of the second communication module 17, executed by the processor 170 to perform operations of the second communication module 17. The second communication module 17 communicates with the wireless communication center 11 via the antenna 171. The second identification unit 175 stores a vehicle ID number, which is not changeable, and is labeled on the vehicle for the user to see. The second communication control unit 173 reads the vehicle ID number from the second identification unit 175 and sends a radio frequency signal containing information of the vehicle ID number to the wireless communication center 11 via the antenna 171. The electronic code lock 177 is electronically connected to the second communication control unit 173.

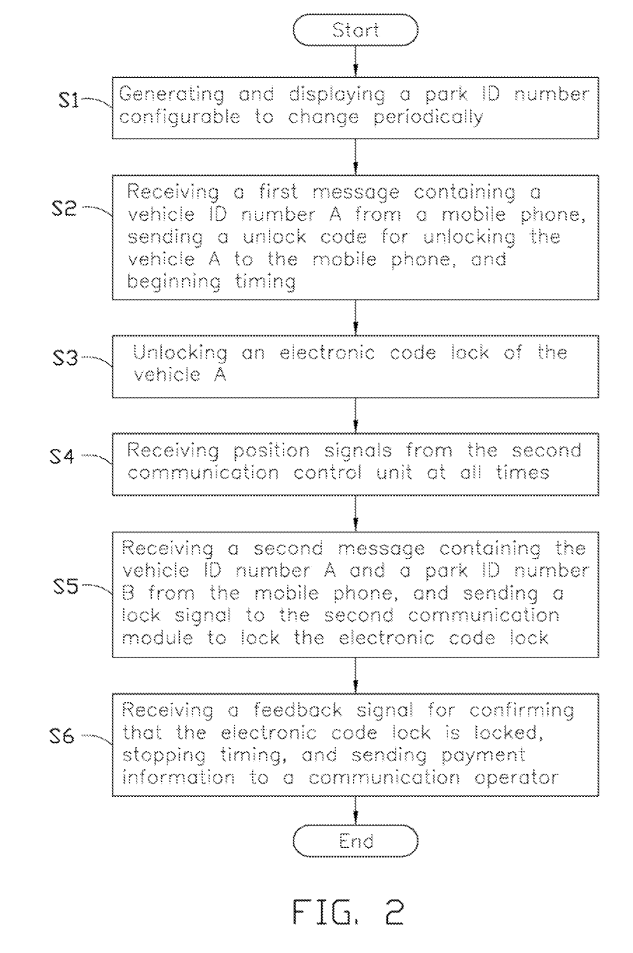

FIG. 2 is a flowchart of one embodiment of a method for vehicle rental management. Depending on the embodiment, additional blocks may be added, others removed, and the ordering of the blocks may be replaced.

In block S1, the wireless communication center 11 sends an identification (ID) radio frequency signal to the antenna 15 via the wireless networks. The ID radio frequency signal received by the antenna 15 is converted to an ID electrical signal via the first communication control unit 153. The first communication control unit 153 sends the ID electrical signal to the first identification unit 155. According to the ID electrical signal, the first identification unit 155 generates a park ID number. The wireless communication center 11 allows the park ID number to change periodically, where the variation period can be 5-10 minutes. The park ID number is displayed on the display screen 157.

In block S2, when a user needs to rent a vehicle, the user has to find a vehicle ID number A labeled on the vehicle for rent and sends a first message containing the vehicle ID number A (such as “using A”) to the wireless communication center 11 via the mobile phone 13. The first processing unit 1151 receives the first message containing the vehicle ID number A, and sends a unlock code corresponding to the electronic code lock 177 of the vehicle A to the mobile phone 13. Meanwhile, the first processing unit 1151 begins timing.

In block S3, the user uses the unlock code to unlock the electronic code lock 177 so that the user can use the vehicle for rent.

In block S4, during use of the vehicle, the first processing unit 1151 receives position signals from the second communication control unit 173 at all times. According to the position signals, the first processing unit 1151 fixes the position of the vehicle.

In block S5, when the user needs to return the vehicle to any one of the plurality of vehicle parking lots, the user sends a second message containing the vehicle ID number A and a park ID number B to the wireless communication center 11 via the mobile phone 13. The park ID number B of the vehicle parking lot changes periodically, thus the user can only see the park ID number B displayed on the display screen 157 when the user has arrived at the vehicle parking lot. The second processing unit 1153 receives the second message, and sends a lock signal to the second communication module 17 to lock the electronic code lock 177. The vehicle communication control unit 173 receives the lock signal, and allows the electronic code lock 177 to lock.

In block S6, when the electronic code lock 177 is locked, the second communication control unit 173 sends a feedback signal to the wireless communication center 11 via the antenna 171 to confirm that the electronic code lock 177 is locked. The first processing unit 1151 receives the feedback signal, stops timing, and sends payment information to a communication operator, (i.e., a wireless carrier) linked to a subscriber identification module (SIM) card of the mobile phone 13. According to the payment information, the communication operator deducts a vehicle rental fee from an account of the SIM card, and sends a deduction message to the mobile phone 13.

During use of the vehicle, when the vehicle is beyond or nearing a predetermined reference point(s), the wireless communication center 11 can send a warning message to the mobile phone 13 to warn the user not to go beyond the predetermined reference point. When the wireless communication center 11 detects that the vehicle is beyond (or going beyond) the predetermined reference points the wireless communication center 11 sends a lock signal to the antenna 171. The second communication control unit 173 receives the lock signal from the antenna 171, and allows the electronic code lock 177 to lock.

When the vehicle is not rented, the second communication control unit 173 sends position signals to the wireless communication center 11 via the antenna 171 at all times. If the wireless communication center 11 detects that the vehicle is moving, the wireless communication center 11 sound a warning to warn system administrators managing the vehicle rental management system 100.

The vehicle rental management system 100 makes it easy to manage the rental vehicles, and the user can conveniently rent or return the vehicle by sending messages via a mobile phone.

In another exemplary embodiment, the antenna 151 can be integrated with the first communication control unit 153, and the antenna 171 can be integrated with the second communication control unit 173.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A wireless communication center communicating with a first communication module located in a vehicle parking lot and a second communication module located in/on a vehicle, the first communication module generating and displaying a park identification (ID) number configurable to change periodically under the control of the wireless communication center, the wireless communication center comprising:
a center processor and a center storage system, wherein one or more programs stored in the center storage system and are executable by the center processor, the one or more programs comprising:
a first processing unit operable to receive a first message containing a vehicle ID number of the vehicle from a mobile phone, unlock the vehicle by sending a unlock code to the mobile phone, receive a feedback signal that confirms that the vehicle is locked from the second communication module, and time between the send the unlock code step and the receive the feedback signal step; and
a second processing unit operable to receive a second message containing the vehicle ID number and a park ID number of the vehicle parking lot from the mobile phone, and lock the vehicle by sending a lock signal to the second communication module, the park ID number displayed by the first communication module.

2. The wireless communication center as claimed in claim 1, wherein the first processing unit receives position signals from the second communication module, and fixes a current position of the vehicle according to the position signals.

3. The wireless communication center as claimed in claim 2, wherein the first communication module comprises a first communication control unit that receives an ID radio frequency signal from the wireless communication center via a wireless network, a first identification unit operable to generate the park ID number according to the ID radio frequency signal, and a display screen that displays the park ID number.

4. The wireless communication center as claimed in claim 3, wherein the second communication module comprises a second communication control unit that communicates with the wireless communication center via the wireless network, an electronic code lock electronically connected to the second communication control unit, and a second identification unit operable to store the vehicle ID number, and send the vehicle ID number to the wireless communication center.

5. The wireless communication center as claimed in claim 4, wherein the first processing unit sends payment information to a communication operator linked to a subscriber identification module (SIM) card of the mobile phone after the time step.

6. The wireless communication center as claimed in claim 5, wherein according to the payment information, the communication operators deducts a vehicle rental fee from an account of the SIM card, and sends a deduction message to the mobile phone.

7. The wireless communication center as claimed in claim 6, wherein the second communication module further comprises an antenna, the second communication module communicates with the wireless communication center via the antenna.

8. The wireless communication center as claimed in claim 6, wherein the first communication module further comprises an antenna, the first communication module communicates with the wireless communication center via the antenna.

9. A method for vehicle rental management, the method comprising:
generating and displaying a park identification (ID) number configurable to change periodically under the control of a wireless communication center;
receiving a first message containing a vehicle ID number of a vehicle from a mobile phone, sending a unlock code for unlocking the vehicle to the mobile phone;
unlocking the vehicle;
receiving position signals from a second communication control unit located on/in the vehicle at all times;
receiving a second message containing the vehicle ID number and the park ID number from the mobile phone, and sending a lock signal to the second communication module to lock the vehicle;
receiving a feedback signal for confirming that the vehicle is locked from the second communication control unit; and
timing between the sending the unlock code step and the receiving the feedback signal step.

10. The method as claimed in claim 9, further comprising:
sending payment information to a communication operator linked to a subscriber identification module (SIM) card of the mobile phone after the timing step.

11. The method as claimed in claim 10, wherein according to the payment information, the communication operators deducts a vehicle rental fee from an account of the SIM card, and sends a deduction message to the mobile phone.

12. The method as claimed in claim 9, wherein a first communication module for generating and displaying the park identification (ID) number comprises a first communication control unit that receives an ID radio frequency signal from the wireless communication center via a wireless network, a first identification unit operable to generate the park ID number according to the ID radio frequency signal, and a display screen that displays the park ID number.

13. The method as claimed in claim 12, wherein the second communication module comprises a second communication control unit that communicates with the wireless communication center via the wireless network, an electronic code lock electronically connected to the second communication control unit, and a second identification unit operable to store the vehicle ID number, and send the vehicle ID number to the wireless communication center.

14. The wireless communication center as claimed in claim 13, wherein the second communication module further comprises an antenna, the second communication module communicates with the wireless communication center via the antenna.

15. The wireless communication center as claimed in claim 13, wherein the first communication module further comprises an antenna, the first communication module communicates with the wireless communication center via the antenna.
